(19) United States
(12) Patent Application Publication
(10) Pub. No.: US 2021/0053191 A1
(43) Pub. Date: Feb. 25, 2021

(54) PILERS

(71) Applicant: ESUN TOOLS MFG. LTD., Taichung City (TW)

(72) Inventor: Chin-Chuan Chen, Taichung City (TW)

(21) Appl. No.: 16/546,220

(22) Filed: Aug. 20, 2019

(51) Int. Cl. B25B 7/12; B25B 7/08; B25B 5/16

(52) U.S. Cl. CPC B25B 7/12; B25B 5/163; B25B 7/08

(57) ABSTRACT

Pliers contains: a first clamp part, a second clamp part, and a spring. The first clamp part includes a first head, a first handle, and two first rotatable connection portions formed between the first head and the first handle. The two first rotatable connection portions respectively have two symmetrical orifices and two first inclined faces. The second clamp part includes a second head, a second handle, and two second rotatable connection portions formed between the second head and the second handle. The two second rotatable connection portions have two central shafts orifices accommodated in the two symmetrical orifices respectively, and the two central shafts orifices have two guide faces corresponding to the two symmetrical orifices respectively; wherein the spring abuts against the first handle and the second handle so that the first head and the second head clamp an object.

### FIELD OF THE INVENTION

The present invention relates to pliers which are capable of rotatably connecting the first clamp part and the second clamp part easily and quickly.

### BACKGROUND OF THE INVENTION

Conventional pliers are disclosed in TW Filing No, 087213550 contain two heads and two handles. The two heads have two positioning sheets extending from two centers of the two heads respectively and fixed by two rotatable connection elements respectively. The two rotatable connection elements are fitted with two torsion springs, and two ends of each spring abuts against an inner wall of each of the two heads. The two heads have two locking plates on which two engagement portions are arranged individually, multiple spaced protrusions arranged on each of the two engagement portions, and multiple slots spaced from the multiple spaced protrusions individually, wherein the two engagement portions are locked with a clamp member formed in a sheet shape, and the two engagement portions have two clamping faces and two posts extending from two centers of the two engagement portions respectively, wherein the two posts are slidably accommodated into one of the multiple slots.

However, the two handle are rotatably connected with the two rotatable connection elements by using two screw nuts difficultly.

The present invention has arisen to mitigate and/or obviate the afore-described disadvantages.

### SUMMARY OF THE INVENTION

The primary aspect of the present invention is to provide pliers which are capable of rotatably connecting the first clamp part and the second clamp part easily and quickly.

To obtain the above mentioned aspect, pliers provided by the present invention contain: a first clamp part, a second clamp part, and a spring.

The first clamp part includes a first head, a first handle, and two first rotatable connection portions formed between the first head and the first handle, wherein the two first rotatable connection portions have two symmetrical orifices formed thereon respectively, and the two first rotatable connection portions have two first inclined faces formed on two inner surfaces thereof individually and extending from two outer surfaces of the two first rotatable connection portions to the two symmetrical orifices respectively.

The second clamp part includes a second head, a second handle, and two second rotatable connection portions formed between the second head and the second handle, wherein the two second rotatable connection portions have two central shafts orifices accommodated in the two symmetrical orifices respectively, and the two central shafts orifices have two guide faces corresponding to the two symmetrical orifices respectively.

The spring abuts against the first handle and the second handle so that the first head and the second head clamp an object.

The two symmetrical orifices include two first shoulders formed on two bottoms of two inner walls thereof respectively, the two central shafts have two locking ribs configured to retain with the two first shoulders individually.

The first handle has a first chamber defined inside an inner surface thereof, the second handle has a second chamber defined inside an inner surface thereof, the first handle further has a first protrusion for abutting against the spring, and the second handle further has a second protrusion for abutting against the spring.

The pliers further contains two retainers, wherein each of the two retainers includes two tabs on which two apertures are formed symmetrically, the two tabs have two second inclined faces formed on two inner surfaces thereof respectively and extending to the two apertures from the two tabs respectively, the first head has a first projection extending from an inner surface thereof and defined between the two tabs, and the second head has a second projection extending from an inner surface thereof and defined between the two tabs; the first head also has two first columns extending from two sides of the first projection respectively, and the second head also has two second columns extending from two sides of the second projection respectively, wherein the two first columns have two first contact portions corresponding to the two second inclined faces of the two tabs respectively, and the two second columns have two second contact portions corresponding to the two second inclined faces of the two tabs respectively.

The two apertures have two second shoulders formed on two bottoms of two inner walls thereof respectively, the two first columns have two first engagement portions for engaging with two second shoulders of the two apertures respectively, and the two second columns have two second engagement portions for engaging with two second shoulders of the two apertures respectively.

The first head has two first serrated sections formed on two sides of the inner surface thereof respectively, and the second head has two second serrated sections formed on two sides of the inner surface thereof respectively.

The first clamp part further includes a first stop plate formed on the inner surface thereof, the second clamp part further includes a second stop plate formed on the inner surface thereof, wherein the first stop plate and the second stop plate are stacked on the spring; wherein the first chamber has a first limitation plate formed therein, and the two first limitation plates have two notches individually for receiving two ends of the spring.

When the first clamp part and the second clamp part are connected, the first rotatable connection portion is pressed onto the second rotatable connection portion, and the two first inclined faces correspond to the two guide faces so that the first rotatable connection portion and the second rotatable connection portion expand and retract. After the two central shafts are aligned with the two symmetrical orifices respectively, they move into the two symmetrical orifices individually so that the first clamp part and the second clamp part are rotatably connected easily and quickly.

### BRIEF DESCRIPTION OF THE DRAWINGS

FIG. 1 is a perspective view showing the assembly of pliers according to a preferred embodiment of the present invention.

FIG. 2 is a perspective view showing the exploded components of the pliers according to the preferred embodiment of the present invention.

FIG. 3 is another perspective view showing the exploded components of the pliers according to the preferred embodiment of the present invention.

FIG. 4 is a perspective view showing the exploded components of a part of the pliers according to the preferred embodiment of the present invention.

FIG. 5 is another perspective view showing the exploded components of a part of the pliers according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

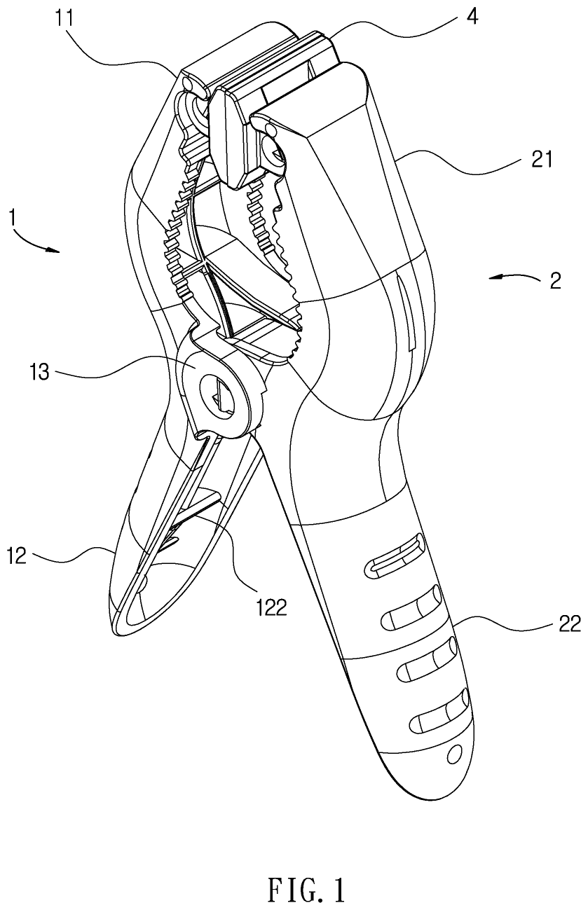

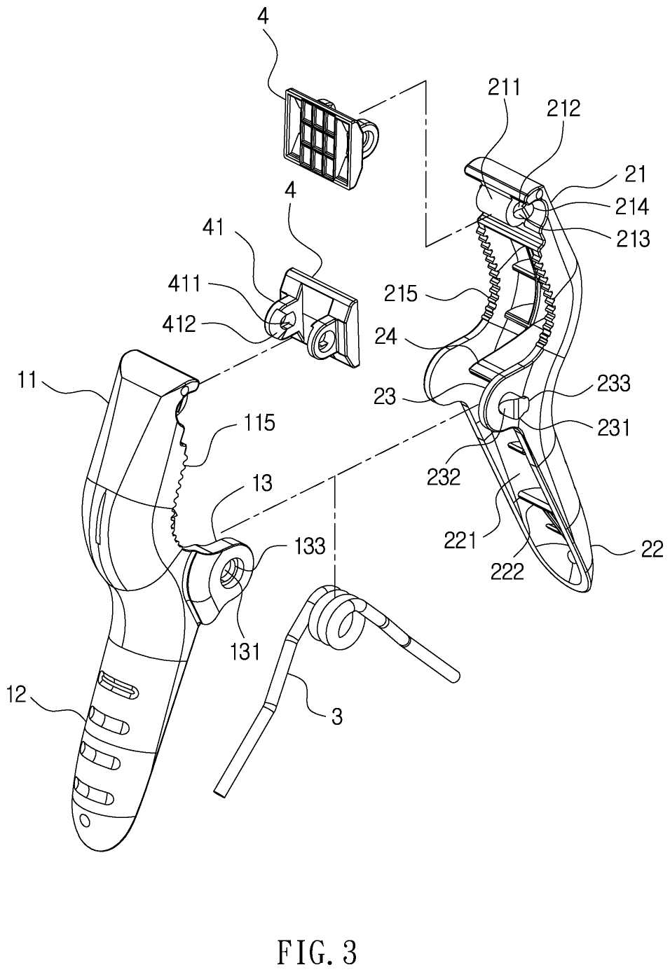

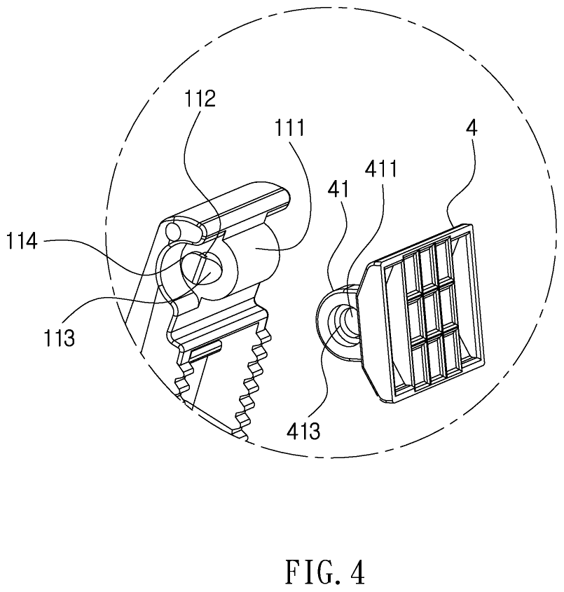

With reference to FIGS. 1-4, pliers according to a preferred embodiment of the present invention comprise: a first clamp part 1, a second clamp part 2, and a spring 3.

The first clamp part 1 includes a first head 11, a first handle 12, and two first rotatable connection portions 13 formed between the first head 11 and the first handle 12, wherein the two first rotatable connection portions 13 have two symmetrical orifices 131 formed thereon respectively, and the two first rotatable connection portions 13 have two first inclined faces 132 formed on two inner surfaces thereof individually and extending from two outer surfaces of the two first rotatable connection portions 13 to the two symmetrical orifices 131 respectively.

The second clamp part 2 includes a second head 21, a second handle 22, and two second rotatable connection portions 23 formed between the second head 21 and the second handle 22, wherein the two second rotatable connection portions 23 have two central shafts orifices 231 accommodated in the two symmetrical orifices 131 respectively, and the two central shafts orifices 231 have two guide faces 232 corresponding to the two symmetrical orifices 131 respectively.

The spring 3 abuts against the first handle 12 and the second handle 22 so that the first head 11 and the second head 21 clamp an object.

When the first clamp part 1 and the second clamp part 2 are connected, the first rotatable connection portion 13 is pressed onto the second rotatable connection portion 23, and the two first inclined faces 132 correspond to the two guide faces 232 individually so that the first rotatable connection portion 13 and the second rotatable connection portion 23 expand and retract. After the two central shafts 231 are aligned with the two symmetrical orifices 131 respectively, they move into the two symmetrical orifices 131 individually so that the first clamp part 1 and the second clamp part 2 are rotatably connected, and the spring 3 is fixed between the first handle 12 and the second handle 22.

The two symmetrical orifices 131 include two first shoulders 133 formed on two bottoms of two inner walls thereof respectively, the two central shafts 231 have two locking ribs 233 configured to retain with the two first shoulders 133 individually so that the first clamp part 1 and the second clamp part 2 are rotatably connected firmly, and the spring 3 pushes the two first shoulders 133 to intersect with the two locking ribs 233 individually.

The first handle 12 has a first chamber 121 defined inside an inner surface thereof, the second handle 22 has a second chamber 121 defined inside an inner surface thereof, the first handle 12 further has a first protrusion 122 for abutting against the spring 3, and the second handle 22 further has a second protrusion 222 for abutting against the spring 3, such that the first protrusion 122 and the second protrusion 222 abut against the spring 3 to fix the spring 3 between the first clamp part 1 and the second clamp part 2.

The pliers further comprise two retainers 4, each of the two retainers 4 includes two tabs 41 on which two apertures 411 are formed symmetrically, the two tabs 41 have two second inclined faces 412 formed on two inner surfaces thereof respectively and extending to the two apertures 411 from the two tabs 41 respectively. The first head 11 has a first projection 111 extending from an inner surface thereof and defined between the two tabs 41, and the second head 21 has a second projection 211 extending from an inner surface thereof and defined between the two tabs 41. The first head 11 also has two first columns 112 extending from two sides of the first projection 111 respectively, and the second head 21 also has two second columns 212 extending from two sides of the second projection 211 respectively, wherein the two first columns 112 have two first contact portions 113 corresponding to the two second inclined faces 412 of the two tabs 41 respectively, and the two second columns 212 have two second contact portions 213 corresponding to the two second inclined faces 412 of the two tabs 41 respectively.

The two apertures 411 have two second shoulders 413 formed on two bottoms of two inner walls thereof respectively, the two first columns 112 have two first engagement portions 114 for engaging with two second shoulders 413 of the two apertures 411 respectively, the two second columns 212 have two second engagement portions 214 for engaging with two second shoulders 413 of the two apertures 411 respectively, such that the two retainers 4 are rotatably connected with the first clamp part 1 and the second clamp part 2 securely.

The first head 11 has two first serrated sections 115 formed on two sides of the inner surface thereof respectively, and the second head 21 has two second serrated sections 215 formed on two sides of the inner surface thereof respectively, such that the first head 11 and the second head 21 clamp the object securely.

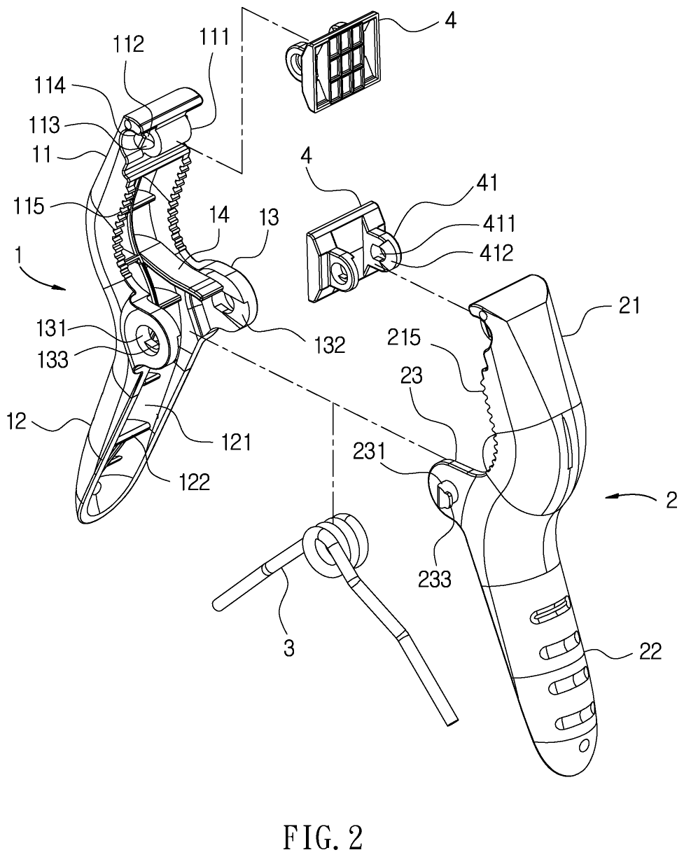

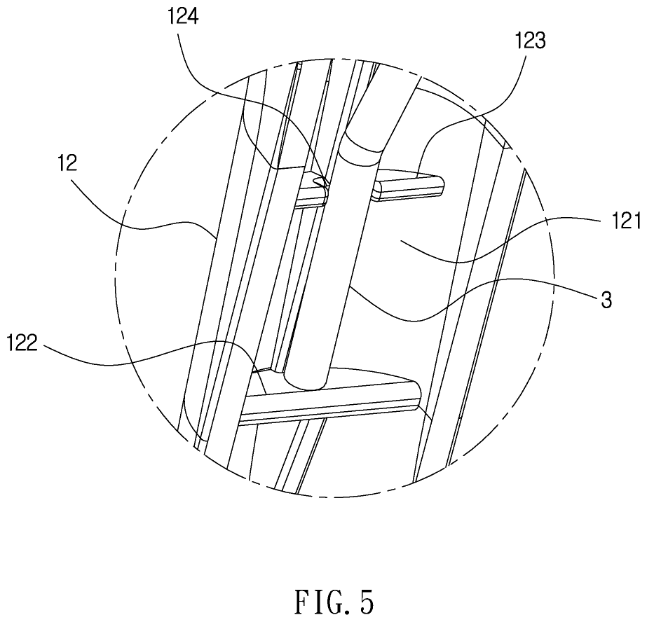

The first clamp part 1 further includes a first stop plate 14 formed on the inner surface thereof, the second clamp part 2 further includes a second stop plate 24 formed on the inner surface thereof, wherein the first stop plate 14 and the second stop plate 24 are stacked on the spring 3, thus fixing the spring 3. Referring to FIG. 5, the first chamber 121 has a first limitation plate 123 formed therein (the first handle 12 is symmetrical to the second handle 22, so it is only amplified in FIGS. 2 and 5), and the two first limitation plates 123 have two notches 124 individually for receiving two ends of the spring 3 fixedly.

When the first clamp part and the second clamp part are connected, the first rotatable connection portion is pressed onto the second rotatable connection portion, and the two first inclined faces correspond to the two guide faces individually so that the first rotatable connection portion and the second rotatable connection portion expand and retract. After the two central shafts are aligned with the two symmetrical orifices respectively, they move into the two symmetrical orifices individually so that the first clamp part and the second clamp part are rotatably connected easily and quickly.

While various embodiments in accordance with the present invention have been shown and described, it is clear to those skilled in the art that further embodiments may be made without departing from the scope of the present invention.

What is claimed is:

1. Pliers comprising: a first clamp part, a second clamp part, and a spring;
wherein the first clamp part includes a first head, a first handle, and two first rotatable connection portions formed between the first head and the first handle, wherein the two first rotatable connection portions have two symmetrical orifices formed thereon respectively, and the two first rotatable connection portions have two first inclined faces formed on two inner surfaces thereof individually and extending from two outer surfaces of the two first rotatable connection portions to the two symmetrical orifices respectively;
wherein the second clamp part includes a second head, a second handle, and two second rotatable connection portions formed between the second head and the second handle, wherein the two second rotatable connection portions have two central shafts orifices accommodated in the two symmetrical orifices respectively, and the two central shafts orifices have two guide faces corresponding to the two symmetrical orifices respectively;
wherein the spring abuts against the first handle and the second handle so that the first head and the second head clamp an object.

2. The pliers as claimed in claim 1, wherein the two symmetrical orifices include two first shoulders formed on two bottoms of two inner walls thereof respectively, the two central shafts have two locking ribs configured to retain with the two first shoulders individually.

3. The pliers as claimed in claim 1, wherein the first handle has a first chamber defined inside an inner surface thereof, the second handle has a second chamber defined inside an inner surface thereof, the first handle further has a first protrusion for abutting against the spring, and the second handle further has a second protrusion for abutting against the spring.

4. The pliers as claimed in claim 1 further comprising two retainers, wherein each of the two retainers includes two tabs on which two apertures are formed symmetrically, the two tabs have two second inclined faces formed on two inner surfaces thereof respectively and extending to the two apertures from the two tabs respectively, the first head has a first projection extending from an inner surface thereof and defined between the two tabs, and the second head has a second projection extending from an inner surface thereof and defined between the two tabs; the first head also has two first columns extending from two sides of the first projection respectively, and the second head also has two second columns extending from two sides of the second projection respectively, wherein the two first columns have two first contact portions corresponding to the two second inclined faces of the two tabs respectively, and the two second columns have two second contact portions corresponding to the two second inclined faces of the two tabs respectively.

5. The pliers as claimed in claim 4, wherein the two apertures have two second shoulders formed on two bottoms of two inner walls thereof respectively, the two first columns have two first engagement portions for engaging with two second shoulders of the two apertures respectively, the two second columns have two second engagement portions for engaging with two second shoulders of the two apertures respectively.

6. The pliers as claimed in claim 1, wherein the first head has two first serrated sections formed on two sides of the inner surface thereof respectively, and the second head has two second serrated sections formed on two sides of the inner surface thereof respectively.

7. The pliers as claimed in claim 3, wherein the first clamp part further includes a first stop plate formed on the inner surface thereof, the second clamp part further includes a second stop plate formed on the inner surface thereof, wherein the first stop plate and the second stop plate are stacked on the spring; wherein the first chamber has a first limitation plate formed therein, and the two first limitation plates have two notches individually for receiving two ends of the spring.
